(19) United States
(12) Patent Application Publication
(10) Pub. No.: US 2015/0087575 A1
(43) Pub. Date: Mar. 26, 2015

(54) RELEASING A CLEANING AGENT WITH AN ENCAPSULATION MATERIAL

(71) Applicant: THE DIAL CORPORATION, SCOTTSDALE, AZ (US)

(72) Inventors: Joan M. Bergstrom, Scottsdale, AZ (US); Gregory A. Konishi, Scottsdale, AZ (US); Travis T. Yarlagadda, Lenexa, KS (US); Catherine Schmit, Glendale, AZ (US)

(73) Assignee: THE DIAL CORPORATION, SCOTTSDALE, AZ (US)

(21) Appl. No.: 14/035,407

(22) Filed: Sep. 24, 2013

(51) Int. Cl. C11D 3/14; A47K 5/02

(52) U.S. Cl. CPC C11D 3/14; A47K 5/02
USPC 510/396; 206/524.1

(57) ABSTRACT

Compositions and apparatus are provided for releasing a cleaning agent with an encapsulation material. An abrasive material and an encapsulation material are disposed within a cleaning product. The encapsulation material is configured to release contents in a cleaning event. A cleaning agent is sorbed by the encapsulation material and configured to be released from the encapsulation material during the event.

### FIELD OF THE INVENTION

The present invention generally relates to releasing of a cleaning agent to clean hard surfaces, and more particularly relates to releasing the cleaning agent from an encapsulation material.

### BACKGROUND OF THE INVENTION

Hard water deposits and soap scum are typically formed on sinks, bathtubs, and other hard surfaces that come into contact with hard water. Such deposits are notoriously difficult to remove. Products that predominately contain abrasives are often used to mechanically scrub off these deposits and other types of soils. However, scrubbing forces that are sufficient to remove these deposits or soils with these abrasive cleaning products often damage the hard surfaces.

Accordingly, it is desirable to have an abrasive cleaning product that is more effective with lower mechanical forces to protect the hard surface. In addition, it is desirable that a cleaning agent be combined with a powder abrasive to lower the mechanical force needed to remove hard water related deposits. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A cleaning product for releasing a cleaning agent with an encapsulation material includes an abrasive material and an encapsulation material that are disposed within the cleaning product. The encapsulation material is configured to at least partially release contents in a cleaning event. A cleaning agent is sorbed by the encapsulation material and configured to be released during the cleaning event.

A hard surface cleaning product for releasing a cleaning agent with an encapsulation material includes a container and a cleaning powder housed within the container. The cleaning powder includes an abrasive material and an encapsulation material disposed within the cleaning powder. The encapsulation material is configured to release its sorbed contents in a scrubbing event. Further, a cleaning agent is sorbed by the encapsulation material and configured to be released from the encapsulation material upon partial break down of the encapsulation material.

A cleaning powder containing a cleaning agent within an encapsulation material includes an abrasive material forming 50.0 to 99.0 weight percent of a cleaning powder and an encapsulation material forming 0.1 to 10.0 weight percent of the cleaning powder. A surfactant sorbed with the encapsulation material forms 0.1 to 20.0 weight percent of the cleaning agent, and an acid sorbed by the encapsulation material forms 0.1 to 30.0 weight percent of the cleaning agent.

### BRIEF DESCRIPTION OF THE DRAWINGS

The present invention will hereinafter be described in conjunction with the following drawing figures, wherein like numerals denote like elements, and

FIG. 1 is a diagram of an example of applying a cleaning powder to a hard water related deposit on a hard surface according to the principles described herein.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The principles described herein include a mechanism for releasing a cleaning agent in a cleaning product during a cleaning event such that the mechanical force needed to remove a deposit is reduced. Such a reduction in the mechanical forces protects the hard surface to be cleaned, saves times, and reduces the energy output of the user cleaning the hard surface. Such a cleaning product includes an encapsulation material that can sorb a cleaning agent. The cleaning agent may be an acid, a surfactant, another cleaning agent, or combinations thereof. A cleaning event may include events such as scrubbing the deposit and/or soil with cleaning powder, adding water to the cleaning powder, other events, or combinations thereof.

The encapsulation material may be silica, hydrophobic silica, hydrophilic silica, fumed silica, another type of encapsulation material other than silica, a porous material, or combinations thereof. The encapsulation material may dissolve in water and thereby release the cleaning agents sorbed by the encapsulation material. For example, a user desiring to clean a hard surface with a deposit thereon may apply the cleaning product and then apply water to the cleaning product in anticipation of scrubbing the hard surface. As the water contacts the encapsulation material, the encapsulation material at least partially releases the cleaning agent. The mechanism of release may be through desorption, through a partial break down of the encapsulation material, through dissolving at least a portion of the encapsulation material, through another mechanism, or combinations thereof. The cleaning agent is released directly onto the hard surface to be cleaned. Thus, the cleaning agent may act upon the hard surface as it is released before other influences in the ambient environment dilute the strength of the cleaning agent.

In another example, the encapsulation material can be broken through mere mechanical forces that are generated through a scrubbing agent against a hard surface. As a result, a user may obtain the advantage of the cleaning agent's strength without applying water to the hard surface or the cleaning agent.

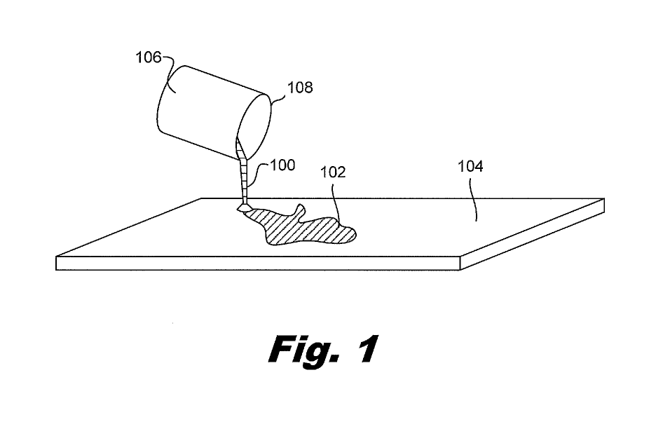

FIG. 1 is a diagram of an example of applying a cleaning powder (100) to a soiled area (102) on a hard surface (104) according to the principles described herein. In this example, the cleaning powder (100) is held within a container (106) that has an opening (108) that allows the cleaning powder (100) to flow out of the container (106) onto the hard surface (104). Once applied to the hard surface (104), the cleaning powder (100) can be scrubbed over the soiled or stained area (102) of the hard surface (104). In some examples, the mechanical action of scrubbing the soiled region (102) with the cleaning powder (100) causes the cleaning agent to be released from an encapsulated material of the cleaning powder (100). In other examples, water or another solvent is added to the cleaning powder (100) to release the cleaning agent.

While the principles herein will be described with specific reference for targeting soils such as hard water related deposits like hard water build up and soap scrum, any appropriate dirty, hard surfaces may be targeted in accordance with these principles. For example, the target soils may be dirt stains, hard water deposits, soap scum, food stains, dye stains, pigment stains, marker stains, chemical stains, other types of stains, or combinations thereof. Examples of hard surfaces may include the surfaces of sinks, bathtubs, shower stalls, faucets, toilets, stainless steel objects, porcelain objects, other surfaces, or combinations thereof.

The cleaning powder (100) may include the following ingredients and corresponding weight percents:

TABLE 1

| Ingredient | Range (weight percent) |
|---|---|
| Calcium Carbonate | 50.0-99.0 |
| Sodium Bicarbonate | 0.1-10.0 |
| Sodium | 0.1-10.0 |
| Dodecylbenzenesulfonate | |
| Encapsulating Material | 0.1-10.0 |
| Fragrance/Perfume | 0.1-1.0 |

In this example, the calcium carbonate is an abrasive material. As a user scrubs the powder against a hard surface, the calcium carbonate rubs against the soiled area and promotes cleaning. While this example has been described with reference to calcium carbonate as the abrasive material, any appropriate type of abrasive material may be used. For example, corundum, sand, pumice, minerals, materials softer than the hard surface, manufactured abrasives, other types of abrasives, or combinations thereof may be used as the abrasive. Further, while this example has been described with a specific range of abrasive materials, any appropriate range of abrasive materials may be used in accordance with the principles described herein.

In some examples, the encapsulating material is silica. In such an example, the silica contains a sorbed cleaning agent. Thus, the cleaning agent is held, as by absorption into or adsorption onto, the silica particles. In some examples, the silica exists as an agglomerate. The silica particles may prevent the cleaning agent from reacting with the other ingredients of the cleaning product while the cleaning product is stored in the container and while the dry/powdered cleaning product resides on the soiled hard surface. For example, if the cleaning agent contains a material with a low pH and another ingredient of the cleaning product includes a material with a high pH, the silica can prevent the high and low pH materials from interacting and neutralizing each other until the cleaning agent is released from the silica. The silica particles can be configured to release any sorbed contents in a solvent added to the hard surface, such as water, or through a mechanical force for scrubbing. While this example will be described with reference to silica as the encapsulation material, any appropriate encapsulation material may be used in accordance with the principles described herein.

While the silica particles are described as having specific weight percents, any appropriate weight percent of silica particles may be used in accordance with the principles described herein. A low weight percentage of the loaded silica particles (0.1 wt % to 10.0 wt %) may not significantly interfere with the cleaning product's ability to flow out of the container (106) or be rubbed across the soiled hard surface. The container (106) may use any appropriate mechanism to make the cleaning product available to users according to the principles described herein. For example, the container (106) may include a replaceable lid that when removed unblocks the container's opening (108) through which the cleaning product (100) can be poured.

By depositing and scrubbing the cleaning product (100) into the soiled area of the hard surface (104), the cleaning agent is positioned to contact the soiled area as the cleaning product is released from the silica particles when the cleaning agent is most effective, just after the cleaning agent is released. For example, if the cleaning agent is highly acidic, the cleaning agent's acidity will be diluted by the solvent or other ingredients of the cleaning product. However, when the cleaning agent is released from the silica particles, the cleaning agent can act on the soiled area before the cleaning agent's acidic properties are significantly diluted by other materials in the cleaning environment. The silica particles of the cleaning product (100) are dispersed throughout the cleaning product (100) and allow the cleaning agent to be held for release upon introduction to a solvent or a rupturing force.

The silica particles may be configured to release in a solvent having, for example, a pH of at least 7, of at least 8, of at least 9, or other pH level. The cleaning agent may be held by the silica particles until the silica particles are at least partially released in the solvent. Upon release, the cleaning agent is at the soiled hard surface and may work the hard surface.

The silica particles may include porous and/or nonporous particles. In some examples, the silica particles include at least some hydrophobic silica particles and/or at least some hydrophilic silica particles. The silica particles can encompass silica particles having varying levels or degrees of hydrophobicity and/or hydrophilicity. The degree of hydrophobicity and/or hydrophilicity imparted to the silica particles will vary depending upon the type and amount of treating agent used to cause the silica particles to be hydrophobic or hydrophilic.

In some examples, hydrophobic silica particles are formed from treated silica particles, such as by fuming or co-fuming the silica particles with silanes or siloxanes. The silica particles may be fumed with the hydrolysis of suitable feed stock vapor (such as silicon tetrachloride) in a flame of hydrogen and oxygen. Molten particles of roughly spherical shape are formed as a result, and the particle diameters may be varied through control of process parameters. These molten spheres, referred to as primary particles, fuse with one another by undergoing collisions at their contact points to form branched, three dimensional chain-like aggregates. The formation of the aggregates is considered to be irreversible as a result of the fusion between the primary particles. During cooling and collecting, the aggregates undergo further collisions that may result in some mechanical entanglements to form agglomerates. These agglomerates are thought to be loosely held together by van der Waals forces and can be reversed, i.e. de-agglomerated, by proper dispersion in a suitable media. Mixed or co-fumed silica particles may also be produced utilizing other techniques. While the silica particles have been described with reference to specific methods for forming the silica particles, any appropriate method of forming the silica particles may be used in accordance with the principles described herein.

The silica particles described herein may include other oxides such as those of aluminum, titanium, zirconium, iron, niobium, vanadium, tungsten, tin, germanium, or combinations thereof. Such aggregates may be formed by introducing appropriate feed stocks (e.g. chloride compounds) into a flame in conjunction with an appropriate fumed silica feed stock. A non-limiting example of fumed silica particles includes AEROSIL® fumed silica available from Evonik Corporation.

In some examples, the treated silica particles have a BET surface area (ASTM D6556-07) of about 35 m²/g to about 700 m²/g, for example, greater than about 60 m²/g, greater than about 80 m²/g, greater than about 130 m²/g, or greater than about 150 m²/g; less than about 400 m²/g, less than about 290 m²/g, less than about 250 m²/g; or about 200 m²/g. While the silica particles have been described with reference to specific surface areas, the silica particles may have any appropriate surface area.

The silica particles may include a mixture of silica particles having different degrees of hydrophobicity or hydrophilicity. For example, the silica particles may include a first portion of hydrophobic silica particles and a second portion of hydrophobic silica particles that is less hydrophobic than the first portion. In some examples, the ratio of more hydrophobic particles to less hydrophobic particles is no more than 50:50, such as less than about 33:66, such as about 25:75. Of course, the ratio of more hydrophobic particles to less hydrophobic particles can be varied to deliver a desired release of the sorbed cleaning agent in the aqueous cleaning environment while inhibiting early non-desired release of the sorbed cleaning agent. Such ratios may range from 1:10 to 10:1. While these examples have been described with reference to specific ratios of varying amounts of hydrophobicity of the silica particles, any appropriate ratio may be used. In other examples, the silica particles include three or more portions that have different degrees of hydrophobicity to control the release of the cleaning agent from the silica particles.

In a non-limiting example, at least some of the silica particles are porous. Such silica particles contain an inner portion and an outer coating with the inner portion being less hydrophobic than the outer coating. The cleaning agent is sorbed by the inner portion of the silica particles. In other words, as a result of the post-loading treatment, the silica particles may be considered to have a less hydrophobic inner portion and a more hydrophobic outer coating. Such an arrangement can control the release timing of the sorbed cleaning agent by making such silica particles more resistant to releasing the cleaning agent.

While the examples above have been described with reference to specific mechanisms for controlling the release of the cleaning agent, any appropriate mechanism for controlling how and when the silica particles release the cleaning agent may be used in accordance with the principles described herein. For example, some of the mechanisms described above may be used to cause some amount of the cleaning agent to be released immediately upon initial introduction into an aqueous cleaning environment while other silica particles are modified to delay a release of the cleaning agent or to slow the release of the cleaning agent. Such timing can provide for a more continuous release of the cleaning agent during an cleaning event to provide a more continuous exposure to the soiled region while the cleaning agent is most effective.

Sodium bicarbonate (also known as baking soda) may be included in the powder and make up 0.1 to 10.0 weight percent of the powder. Sodium bicarbonate is another cleaning agent that can contribute to a chemical cleaning reaction with the cleaning agent released from the encapsulation material. Sodium dodecylbenzenesulfonate is a surfactant and may make up 0.1 to 10.0 weight percent of the powder.

The cleaning agent that is sorbed into or onto the encapsulation material may be any appropriate cleaning agent for removing stains that would otherwise be incompatible with the other ingredients of the cleaning powder. For example, the cleaning agent may include a phosphoric acid, an alpha hydroxy acid, a formic acid, a citric acid, an acid salt, an acid precursor, another type of acid, a surfactant, another type of material, or combinations thereof. In some examples, the cleaning agent is an aqueous material. In other examples, portions of the cleaning agent include solid materials. An aqueous material of the cleaning agent may have a pH of less than about 3.5, for example less than about 2, such as less than about 1.5, for example less than about 1.

An example of the cleaning agent(s) that may be loaded into or onto the encapsulated material may include the following ingredients and corresponding weight percents of the cleaning agent(s):

TABLE 2

| Ingredient | Range (weight percent) |
|---|---|
| Alkyl Polyglucoside | 1.0 to 8.0 |
| Fatty Alcohol Ethoxylate C12-14 | 0.01 to 2.0 |
| Sodium Citrate | 0.1 to 6.0 |
| Phosphoric Acid | 1.0 to 8.0 |
| Citric Acid | 4.0 to 15.0 |
| Formic Acid | 0.1 to 6.0 |
| Sodium Hydroxide | 0.1 to 6.0 |
| Polydimethyl siloxane | Less than 1.0 |
| Zinc Ricinoleate | 0.1 to 6.0 |
| Antifoam | 0.01 to 2.0 |
| Emulsifier | Less than 1.0 |
| Water | 50.0 to 100.0 |

In another example, the cleaning agent(s) that may be loaded into or onto the encapsulated material may include the following ingredients and corresponding weight percents of the cleaning agent(s):

TABLE 3

| Ingredient | Range (weight percent) |
|---|---|
| Surfactant | 0.1-20.0 |
| Organic or inorganic | 0.1-30.0 |
| acid | |
| Water | 50.0-99.0 |

In yet another example, the cleaning agent(s) that may be loaded into or onto the encapsulated material may include the following ingredients and corresponding weight percents of the cleaning agent(s):

TABLE 4

| Ingredient | Range (weight percent) |
|---|---|
| Water | 87.0-92.0 |
| Lactic Acid | 4.0-6.0 |
| Sodium | 4.0-6.0 |
| Dodecylbenzenesulfonate | |
| Alkylpolyglucoside | 0.1-2.0 |
| Sodium Hydroxide | 0.1-0.5 |
| (50%) | |
| Fragrance | 0.1-0.5 |

Any appropriate type of acid may be an ingredient of the cleaning agent that is sorbed into or onto the encapsulation material. The overall amount of acid (a single acid or combinations of acids) may include 0.1 to 30.0 weight percent of the cleaning agent. Such acids may include phosphoric acid, alpha hydroxy acid, nitric acid, sulfamic acid, sodium acid sulfate, hydrochloric acid, hydroxyacetic acid, citric acid, gluconic acid, formic acid, acid salts, or combinations thereof.

Hydroxy acid refers to a compound having a carboxylic acid functionality and a hydroxy functionality. Alpha-hydroxy acids have a mono- or polycarboxylic acid containing one or more hydroxyl functions, at least one of these hydroxyl functions occupies a position alpha to the acid (carbon adjacent to a carboxylic function). In certain examples, the alpha hydroxy acid is selected from linear or branched alpha hydroxy acids no more than six carbon atoms and aromatic alpha hydroxy acids. The powder and/or cleaning agent may, of course, contain one or more alpha hydroxy acids. The alpha hydroxy acid may include, without limitation, gluconic acid, malic acid, citric acid, glycolic acid, lactic acid, mandelic acid, methyllactic acid, phenyllactic acid, tartronic acid, tartaric acid, benzylic acid, 2-hydroxycaprylic acid, salicylic acid, maleic acid, pyruvic acid, hydroxy-octanoic acid, or combinations thereof. Alpha hydroxy acids may cause local irritation when applied to sensitive areas of the skin. Thus, the silica particles do not just prevent the cleaning agent from being affected by the other ingredients of the powder, but the silica particles can also protect the user's skin while rubbing the powder on the hard surface.

Phosphoric acid may also be used in the powder as an acidic agent and/or as complexing or softening agents to reduce the hardness of the water used in cleaning. Water softeners remove Ca2+ and Mg2+ ions from “hard” water. If not removed, these hard-water ions react with soap and form insoluble deposits that cling to hard surfaces. The phosphoric acid causes the Ca2+ and Mg2+ ions to form soluble chemical species, called complexes or chelates. These complexes prevent the Ca2+ and Mg2+ from reacting with soap and forming deposits.

While the above examples have been described with reference to specific types of acids as the cleaning agent, any appropriate acid or other type of agent may be used in accordance with the principles described herein. For example, other acids, such nitric acid, sulfamic acid, hydrochloric acid, and hydroxyacetic acid may be used in the cleaning agent. Further, the cleaning agent may work in conjunction with acid salts or other non-aqueous agents.

An acid salt may include any appropriate salt in the powder, such as water soluble acid salts, citric acid salts, citrates, sodium citrates, monosodium citrate, sodium dihydrogen citrate, other types of salt, or combinations thereof. The acid salts may be used to directly assist with cleaning the hard surface, or the acid salts may indirectly assist with cleaning the surface. Acid salts may be included to provide additional acidity when the cleaning agent is released from the encapsulation material. Specifically, the acid mixture of the sorbed cleaning agent may promote the acid salt to turn into an acid. For example, sodium dihydrogen citrate may be driven to citric acid. As a result, the deliverable amount of citric acid to the targeted soiled area may be higher than the amount of citric acid in the sorbed cleaning agent. By using acid salts, the increased amount of acid delivered to the soil is achieved without increasing skin irritation to the user.

Sodium citrate is sodium salt of citric acid. Sodium citrate may make up 0.1 to 6.0 weight percent of the cleaning agent that is sorbed into the encapsulation material. Zinc ricinoleate is zinc salt of ricinoleic acid that has odor absorbing properties. Zinc ricinoleate may make up 0.1 to 6.0 weight percent of the cleaning agent that is sorbed into the encapsulation material.

The cleaning agent may include a surfactant. In some examples, the surfactant constitutes 0.1 to 20.0 weight percent of the cleaning agent sorbed by the encapsulation material. A surfactant is a compound that lowers the surface tension of a liquid or the interfacial tension between two liquids or between a liquid and a solid. When added to water during hard surface cleaning, a surfactant significantly reduces the surface tension of the water allowing the water to penetrate the soiled area. The result is that the water can function more effectively, acting to loosen the dirt or other debris from the hard surface, and then hold the dirt until the dirt can be washed away.

Surfactants have a hydrophobic end and a hydrophilic end. The hydrophobic end has an uncharged carbohydrate group that can be straight, branched, cyclic or aromatic. Depending on the nature of the hydrophilic part the surfactants are classified as anionic, nonionic, cationic or amphoteric. Anionic surfactants have a hydrophilic end that has a negatively charged group like a sulfonate, sulfate, or carboxylate and are sensitive to water hardness. Nonionic surfactants include a non-charged hydrophilic part, e.g. an ethoxylate. Nonionic surfactants are not sensitive to water hardness. Cationic surfactants have a hydrophilic end that contains a positively-charged ion. Amphoteric surfactants or Zwitterionic surfactants have both cationic and anionic centers attached to the same molecule. The surfactants in the powder may include any appropriate type of mixture of surfactants. For example, the surfactants may include a blend of anionic and nonionic surfactants.

Fatty alcohol ethoxylate C12-14 are surfactants that are produced through the process of ethoxylation where ethylene oxides are added to alcohols and phenols. Fatty alcohol ethoxylate C12-14 may make up 0.01 to 2.0 weight percent of the cleaning agent that is sorbed into the encapsulation material. Sodium dodecylbenzenesulfonate is a surfactant with a chemical makeup of C₁₂H₂₅C₆H₄SO₃Na. The sodium dodecylbenzenesulfonate may make up 4.0 to 6.0 weight percent of the cleaning agent that is sorbed into the encapsulation material. Alkyl polyglucoside is a surfactant that is derived from sugars and fatty alcohols. The alkyl polyglucoside may make up 0.1 to 2.0 weight percent of the cleaning agent that is sorbed into the encapsulation material.

Polydimethyl siloxane is a silicon based organic polymer that improves the flow properties of compounds. The polydimethyl siloxane may make up less than 1.0 weight percent of the cleaning agent that is sorbed into the encapsulation material.

An antifoam is a chemical additive that reduces the formation of foam in a composition. The antifoam may make up 0.01 to 2.0 weight percent of the cleaning agent that is sorbed into the encapsulation material. The antifoam may be an oil based antifoam, another type of antifoam, combinations thereof.

An emulsifier is a substance that stabilizes an emulsion, such as the cleaning agent that is sorbed into the encapsulation material. The emulsifier may make up less than 1.0 weight percent of the cleaning agent that is sorbed into the encapsulation material. Any appropriate emulsifier may be used in accordance with the principles described herein. For example, the emulsifier may be silicone-based water-in-oil emulsifiers, poly-(C₂-C₃)alkylene glycol-modified silicones, dimethicone copolyol, bis-PEG-y dimethicone (with y=3-25, preferably 4-20), PEG/PPG-a/b dimethicone (wherein a and b mutually independently denote numbers from 2-30, for example 3-30, such as 14-18), bis-PEG/PPG-c/d dimethicone (wherein c and d mutually independently denote numbers from 10-25, for example 14-20, such as 14-16), and bis-PEG/PPG-e/f PEG/PPG-g/h dimethicone (wherein e, f, g and h mutually independently denote numbers from 10-20, for example 14-18, such as particularly preferably 16). Further silicone-based water-in-oil emulsifiers may be employed in accordance with the principles described herein are poly-(C₂-C₃)-alkylene glycol-modified silicones, which are hydrophobically modified with C₄-C₁₈ alkyl groups, for example cetyl PEG/PPG-10/1 dimethicone, alkyl methicone copolyols, and alkyl dimethicone ethoxy glucoside.

Sodium hydroxide is a corrosive metallic base and an alkali salt. The sodium hydroxide (with a 50% saturation) may make up 0.1 to 0.5 weight percent of the cleaning agent that is sorbed into the encapsulation material. Fragrances may be included in the powder to provide a pleasant smell.

Any appropriate method of making the cleaning powder, the silica particles, and/or the cleaning agent may be used in accordance with the principles described herein. A method for making the cleaning agent includes mixing water, the cleaning agent, and in some cases additional materials to form an aqueous cleaning agent. The aqueous cleaning agent may have a pH of less than 2, such as less than 1. The aqueous cleaning agent remains flowable despite its high acid content. Further, the method may include mixing acid salts, such as citrates, into the cleaning agent.

After the aqueous cleaning agent is prepared, it may be sorbed by the silica particles. After sorbing the aqueous cleaning agent with the silica particles, the powder may be loaded into the container.

While the above examples have been described with reference to specific types of cleaning agents, any appropriate cleaning agent may be used in accordance with the principles described herein. For example, the cleaning agents may be used to remove soils, inhibit the formation of soils, or otherwise contribute to cleaning the soils. In some examples, the cleaning agent contributes directly to cleaning the soils by directly working on the soils. In other examples, the cleaning agent indirectly cleans the soils. For example, the cleaning agent may lower the water hardness, affect the surrounding environment in another way, or combinations thereof. Further, the cleaning agent may include multiple types of cleaning agents that work on the soils. In such examples, each of the cleaning agents may perform different functions, perform overlapping functions, perform the same functions, or combinations thereof.

While the examples above have been described with specific reference to cleaning agents that are acidic, the cleaning agent may have any appropriate property that contributes to cleaning the surface in accordance with the principles described herein. For example, the cleaning agent may have an acidic property, an alkaline property, an abrasive property, a chemical property, a surfactant property, another type of property, or combinations thereof that contribute to cleaning of hard surfaces.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A cleaning product for releasing a cleaning agent with an encapsulation material, comprising:
an abrasive material and an encapsulation material disposed within the cleaning product;
the encapsulation material being configured to at least partially release contents in a cleaning event; and
a cleaning agent sorbed by the encapsulation material and configured to be released from the encapsulation material during the cleaning event.

2. The cleaning product of claim 1, wherein the cleaning event is an introduction of a solvent.

3. The cleaning product of claim 1, wherein the cleaning event is a mechanical rubbing of the abrasive material.

4. The cleaning product of claim 1, wherein the abrasive material is calcium carbonate.

5. The cleaning product of claim 1, wherein the encapsulation material is silica.

6. The cleaning product of claim 1, wherein the cleaning agent is includes an acid.

7. The cleaning product of claim 6, wherein the acid is 0.1 to 30.0 weight percent of the cleaning agent.

8. The cleaning product of claim 6, wherein the acid includes phosphoric acid, alpha hydroxy acid, nitric acid, sulfamic acid, sodium acid sulfate, hydrochloric acid, hydroxyacetic acid, citric acid, gluconic acid, formic acid, acid salts, or combinations thereof.

9. The cleaning product of claim 1, wherein the cleaning agent includes a surfactant.

10. The cleaning product of claim 9, wherein the surfactant is 0.1 to 20.0 weight percent of the cleaning agent.

11. The cleaning product of claim 1, wherein the cleaning product is configured to clean a hard surface.

12. The cleaning product of claim 1, wherein encapsulation material is up to 10.0 weight percent of the cleaning product.

13. A hard surface cleaning product for releasing a cleaning agent with an encapsulation material, comprising:
a container; and
a cleaning powder housed within the container, wherein the cleaning powder includes:
an abrasive material and an encapsulation material disposed within the cleaning powder;
the encapsulation material configured to at least partially release its contents in a scrubbing event; and
a cleaning agent sorbed by the encapsulation material and configured to be released from the encapsulation material upon partial break down of the encapsulation material.

14. The product of claim 13, wherein the abrasive material is 50.0 to 99.0 weight percent of the cleaning powder.

15. The product of claim 13, wherein the encapsulation material is 0.1 to 10.0 weight percent of the cleaning powder.

16. The product of claim 13, wherein the encapsulation material comprises a surfactant that is 0.1 to 20.0 weight percent of the cleaning agent.

17. The product of claim 13, wherein the encapsulation material comprises an acid that is 0.1 to 30.0 weight percent of the cleaning agent.

18. A cleaning powder containing a cleaning agent with an encapsulation material, comprising:
an abrasive material forming 50.0 to 99.0 weight percent of a cleaning powder;
an encapsulation material forming 0.1 to 10.0 weight percent of the cleaning powder;
a surfactant sorbed with the encapsulation material forming 0.1 to 20.0 weight percent of the cleaning agent; and
an acid sorbed by the encapsulation material forming 0.1 to 30.0 weight percent of the cleaning agent.

19. The cleaning powder of claim 18, wherein the encapsulation material includes silica particles.

20. The cleaning powder of claim 18, wherein the abrasive material is a calcium carbonate.
